(19) United States
(12) Patent Application Publication
(10) Pub. No.: US 2026/0019346 A1
(43) Pub. Date: Jan. 15, 2026

(54) METHODS AND APPARATUS FOR QOS MONITORING

(71) Applicant: Telefonaktiebolaget LM Ericsson (publ), Stockholm (SE)

(72) Inventors: Hong ZHANG, Göteborg (SE); Yumei SONG, Göteborg (SE); Susana FERNANDEZ ALONSO, Madrid (ES); Fuencisla GARCIA AZORERO, Madrid (ES)

(21) Appl. No.: 18/993,742

(22) PCT Filed: Oct. 27, 2022
(86) PCT No.: PCT/EP2022/080066

§ 371 Date: Jan. 13, 2025

(30) Foreign Application Priority Data
Jul. 26, 2022 (EP) 22382716.3

(51) Int. Cl. H04L 41/5009

(52) U.S. Cl. CPC H04L 41/5009

(57) ABSTRACT

A method and apparatus for QoS monitoring support in a communication network. The method includes determining, by a network management unit, whether or not QoS monitoring is supported by at least one network unit. If it is determined that QoS monitoring is supported by the at least one network unit, the method includes receiving a QoS monitoring report and sending a QoS monitoring support notification. If it is determined that QoS monitoring is not supported by the at least one network unit, the method includes sending a QoS monitoring support notification.

### TECHNICAL FIELD

Embodiments of the present disclosure relate to methods and apparatus in communication networks, and particularly methods and apparatus for Quality of Service (QOS) monitoring support notification in communication networks.

### BACKGROUND

QoS monitoring is integral to the correct operation of various communication networks, for example, 4^{th} Generation (4G) or 5^{th} Generation (5G) wireless networks operating in accordance with the specifications established by the 3^{rd} Generation Partnership Project (3GPP). In addition to helping detect network faults or issues, it is common for service agreements between network providers and operators to include QoS guarantees (by way of example, guarantees that transmission delays will not exceed a given level) and corresponding penalties for breaching these QoS guarantees. Accordingly, monitoring of QoS parameters is a key task in network operations.

3GPP communication networks comprise large numbers of different functions, several of which may be involved in QoS monitoring. Some examples of functions which may be involved are discussed below.

The Application Function (AF) interacts with the 3GPP Core Network and may be used, for example, to exchange information between a Content Provider and a Network Operator. In this context, the content provider is a user of the network, that routes data traffic through the network via the use of network resources. The network operator is the owner and operator of the network, typically a company that charges content providers for use of network resources.

The Policy Control Function (PCF) supports unified policy framework to govern the network behaviour. As an example of this, the PCF may provide PCC (Policy and Charging Control) rules to the Policy and Charging Enforcement Function, PCEF, that enforces policy and charging decisions according to the provisioned PCC rules.

The PCEF may comprise the Session Management Function (SMF) and the User Plane Function (UPF). The Session Management function (SMF) supports different functionality, specifically the SMF may receive PCC rules from PCF and configure the UPF accordingly. The User Plane Function (UPF) supports handling of user plane traffic based on the rules received from SMF, specifically the UPF may support packet inspection and different enforcement actions (e.g. HTTP header enrichment).

The Network Exposure Function (NEF) acts as an entry point into a network for an external Application Function (AF), such as that of a device, where the device may be an IoT device. The NEF thereby securely exposes network capabilities and events provided by 3GPP network functions to external AFs.

3GPP TS 23.501 V17.5.0, a technical report of the 3rd Generation Partnership Project available at https://portal.3gpp.org/desktopmodules/Specifications/SpecificationDetails.aspx?specificationId=3144 as of 20 Jul. 2022, discusses the provision of QoS monitoring in 5G networks. In particular, section 5.33.3, discusses QoS Monitoring to Assist Ultra Reliable Low Latency Communications (URLLC). Clause 5.33.3.2 specifies the per QoS Flow per User Equipment (UE) QoS monitoring. As discussed in this clause, the SMF, based on QoS monitoring policies received from an AF via the PCF (for example), may send a QoS Monitoring request to the PDU (Protocol Data Unit) Session Anchor (PSA) UPF via N4 signalling and to a Next Generation RAN (Radio Access Network) (NG-RAN) via N2 signalling to request the QoS monitoring between PSA UPF and NG-RAN.

The NG-RAN may initiate the RAN part of uplink/downlink (UL/DL) packet delay measurement based on the QoS Monitoring request from SMF. Further, the NG-RAN may report the RAN part of an UL/DL packet delay result to the PSA UPF in the UL data packet or a dummy UL packet.

The PSA UPF may create and send monitoring packets to the RAN at a measurement frequency, decided by the PSA UPF. In particular:
The PSA UPF may encapsulate in the GPRS Tunnelling Protocol-User Plane (GTP-U) header with QoS Flow Indicator (QFI), a QoS Monitoring Packet (QMP) indicator (which indicates the packet is used for UL/DL packet delay measurement) and the local time T1 when the PSA UPF sends out the DL monitoring packets.
The NG-RAN may record the local time T1 received in the GTP-U header and the local time T2 at the reception of the DL monitoring packets.
When receiving an UL packet from a UE for that QFI or when the NG-RAN sends a dummy UL packet as monitoring response (in case there is no UL service packet for UL packet delay monitoring), the NG-RAN may then encapsulate the QMP indicator, the RAN part of UL/DL packet delay result, the time T1 received in the GTP-U header, the local time T2 at the reception of the DL monitoring packet and the local time T3 when NG-RAN sends out this monitoring response packet to the UPF via N3 interface, in the GTP-U header of the monitoring response packet. When the NG-RAN sends the dummy UL packet as monitoring response to PSA UPF depends on NG-RAN's implementation.
The PSA UPF may then record the local time T4 when receiving the monitoring response packets and calculate the round trip (if not time synchronized) or UL/DL packet delay (if time synchronized) between NG-RAN and anchor PSA UPF based on the time information contained in the GTP-U header of the received monitoring response packet. If the NG-RAN and PSA UPF are not time synchronised, the PSA UPF calculates the UL/DL packet delay between the NG-RAN and the PSA UPF based on the (T2−T1+T4−T3)/2. If the NG-RAN and PSA UPF are time synchronised, the PSA UPF calculates the UL packet delay and DL packet delay between the NG-RAN and the PSA UPF based on (T4−T3) and (T2−T1), respectively. The PSA UPF calculates the UL/DL packet delay between UE and PSA UPF based on the received RAN part of UL/DL packet delay result and the calculated UL/DL packet delay between RAN and PSA UPF. The PSA UPF may then report the result to the SMF based on some specific condition, e.g. when threshold for reporting to SMF is reached.

Typically, there is little or no provision for detection and reporting of issues with QoS monitoring procedures. 3GPP TS 29.244 V17.5.0, a technical report of the 3rd Generation Partnership Project available at https://portal.3gpp.org/desktopmodules/Specifications/SpecificationDetails.aspx?specificationId=3111 as of 20 Jul. 2022, discusses how, when the PSA UPF is performing QoS monitoring and does not receive from the RAN the UL packet delay for a delay exceeding the Packet Delay Thresholds, the UPF may generate a QoS monitoring report indicating packet delay measurement failure to the SMF. FIG. 1 is a bit diagram indicating how the QoS monitoring report indicating packet delay measurement failure may be configured; essentially the bit 4 PLMF (Packet Delay Measurement Failure) bit may be set to “1”, thereby indicating no timestamp has been received in uplink packet for a delay exceeding the Packet Delay Thresholds or the Measurement Period. Further, as discussed in section 6.3.1 of 3GPP TS 29.503 V17.7.0, a technical report of the 3rd Generation Partnership Project available at https://portal.3gpp.org/desktopmodules/Specifications/SpecificationDetails.aspx?specificationId=3342 as of 20 Jul. 2022, the UPF may report a packet delay measurement failure to the SMF and the SMF may report the same to the PCF or to the AF. The UPF may make use of the Reporting threshold(s) or the Measurement Period as default threshold for reporting packet delay measurement failure, when no measurement result (no RAN measurement and/or no time stamp in UL packet from RAN) is received for a delay exceeding this threshold. Accordingly, instances of packet delay measurement failure may be communicated between functions in a 3GPP network.

With the exception of packet delay measurement failures as discussed above, current systems typically do not provide notifications between different functions that may be used to indicate QoS monitoring failures, or support (or lack of support) for QoS monitoring. As a consequence, expected QoS monitoring reports may be missing without notice, potentially resulting in unexpected errors in the applications expecting the reports. Also, where a UPF relocation results in QoS monitoring support being available that was previously not available (due to lack of support in a UPF used prior to relocation) or vice versa, it is possible that an AF seeking QoS reports may be unaware of the changes in QoS monitoring support availability. Accordingly, the proper operation of the network may be hampered.

### SUMMARY

It is an object of the present disclosure to facilitate the transfer of information relating to QoS monitoring support in communication networks.

Embodiments of the disclosure aim to provide apparatuses and methods that alleviate some or all of the problems identified.

An embodiment of the disclosure provides a method for QoS monitoring support notification in a communication network. The method comprises determining, by a network management unit, whether or not QoS monitoring is supported by at least one network unit. If it is determined that QoS monitoring is supported by the at least one network unit, the method further comprises receiving a QoS monitoring report and sending a QoS monitoring support notification. If it is determined that QoS monitoring is not supported by the at least one network unit, the method further comprises sending a QoS monitoring support notification.

A further embodiment of the disclosure provides a method for QoS monitoring support notification in a communication network. The method comprises sending, by an AF node, a QoS monitoring support notification request to a network management unit. The method further comprises receiving, by the AF node, a QoS monitoring support notification from the network management unit.

A further embodiment of the disclosure provides a network management unit for QoS monitoring support notification in a communication network, the network management unit comprising processing circuitry and a non-transitory machine-readable medium storing instructions. The network management unit is configured to determine whether or not QoS monitoring is supported by at least one network unit. If it is determined that QoS monitoring is supported by the at least one network unit, the network management unit is configured to receive a QoS monitoring report and send a QoS monitoring support notification. If it is determined that QoS monitoring is not supported by the at least one network unit, the network management unit is configured to send a QoS monitoring support notification.

A further embodiment of the disclosure provides an AF node for QoS monitoring support notification in a communication network, the AF node comprising processing circuitry and a non-transitory machine-readable medium storing instructions. The AF node is configured to send a QoS monitoring support notification request to a network management unit. The AF node is further configured to receive a QoS monitoring support notification from the network management unit.

Further embodiments provide methods, network management units, AF nodes and systems as discussed herein.

### BRIEF DESCRIPTION OF DRAWINGS

For a better understanding of the present disclosure, and to show how it may be put into effect, reference will now be made, by way of example only, to the accompanying drawings, in which:

FIG. 1 is a bit diagram indicating how the QoS monitoring report indicating packet delay measurement failure may be configured;

FIG. 2 is a flowchart of a method for QoS monitoring support notification in a communication network, in accordance with embodiments;

FIGS. 3 is a flowchart of a further method for QoS monitoring support notification in a communication network, in accordance with embodiments;

FIG. 4A and FIG. 4B (collectively referred to as FIG. 4) are schematic diagrams of network management units in accordance with embodiments;

FIG. 5A and FIG. 5B (collectively referred to as FIG. 5) are schematic diagrams of AF nodes in accordance with embodiments; and

FIG. 6A and FIG. 6B (collectively referred to as FIG. 5) are a signalling diagram for a QoS monitoring support notification process according to an example of an embodiment.

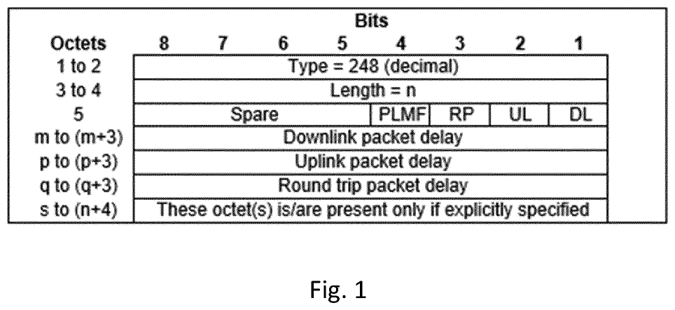

### DETAILED DESCRIPTION

The following sets forth specific details, such as particular embodiments for purposes of explanation and not limitation. It will be appreciated by one skilled in the art that other embodiments may be employed apart from these specific details. In some instances, detailed descriptions of well-known methods, nodes, interfaces, circuits, and devices are omitted so as to not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAS, etc.) and/or using software programs and data in conjunction with one or more digital microprocessors or general purpose computers that are specially adapted to carry out the processing disclosed herein, based on the execution of such programs. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions. In terms of computer implementation, a computer is generally understood to comprise one or more processors, one or more processing modules or one or more controllers, and the terms computer, processor, processing module and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

Current systems may not provide reporting capabilities covering a variety of QoS monitoring situations, including QoS failures or errors. Two examples of QoS monitoring errors that may not be accounted for in existing systems are: when a SMF detects a UPF does not support QoS monitoring; and when a SMF detects a UPF does not support Direct Notification. With reference to the first of these situations, section 4.3.3.2 step 8 of 3GPP TS 23.502 V17.5.0, a technical report of the 3rd Generation Partnership Project available at https://portal.3gpp.org/desktopmodules/Specifications/SpecificationDetails.aspx?specificationId=3145 as of 20 Jul. 2022 states “If the QoS Monitoring for URLLC is enabled for the QoS Flow, the SMF provides the N4 rules containing the QoS Monitoring policy generated according to the information received in step 1b to the UPF via the N4 Session Modification Request message.” There is no provision for situations in which the selected UPF (selected according to the current selection criteria, such as user location, APN, and so on) for the PDU session does not support QoS monitoring, and/or there is no possibility for the SMF to select a UPF that supports QoS monitoring. With reference to the second of the situations, when a SMF provides N4 rules containing QoS Monitoring policy that contain the Direct Notification indication, it might occur that the relevant UPF does not support the notification to local NEF.

Aspects of embodiments may provide methods and apparatus for facilitating the transfer of QoS monitoring support notifications between network management units (such as SMFs), AFs, PCF, NEFs, UPFs and so on. As such, the various functions and units within the network may have access to more information regarding the availability of QoS monitoring support, and the efficient operation of the network may be supported.

Embodiments enable the report of QoS monitoring support of, for example, UPFs and/or RAN nodes. The reporting may be enabled as an outcome of the QoS Monitoring Information provisioning. Embodiments therefore provide mechanisms allowing the AF to be aware of the QoS monitoring support in the access network, thereby allowing the AF to react accordingly, avoiding erroneous behaviour in the concerned developed applications.

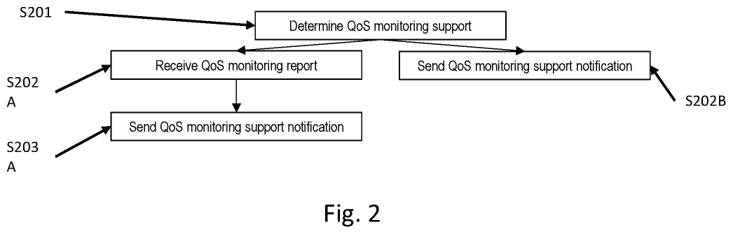

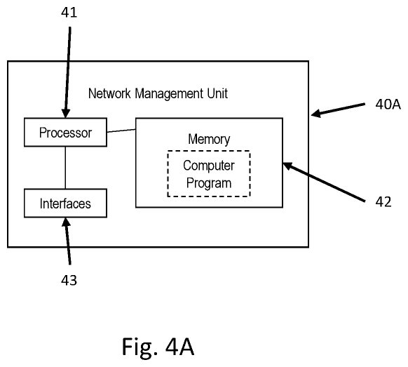

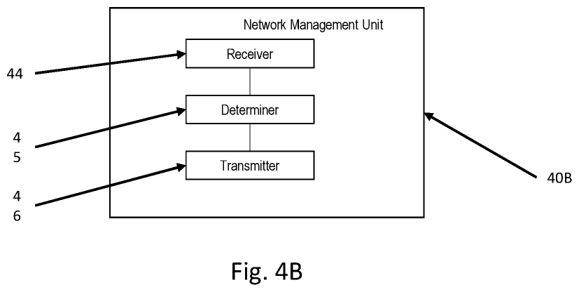

FIG. 2 is a flowchart of a method for QoS monitoring support notification in a communication network, in accordance with embodiments. The method may be performed by a network management unit (such as a SMF), and may comprise determining, by the network management unit, whether or not QoS monitoring is supported by at least one network unit (see step S201). The determination may be made with respect to one or more network units, which may include one or more UPFs and/or one or more NG-RANs. The network management unit may be, for example, the network management unit 40 of FIG. 4A or FIG. 4B. The determination may be made by the processor 41 of the network management unit 40A shown in FIG. 4A, where the processor 41 may be executing instructions stored in the memory 42. Alternatively, the determination may be made by the determiner 45 of the network management unit 40B shown in FIG. 4B.

In some embodiments, the determination may be made subsequent to the receipt of a QoS monitoring support notification request from an AF, wherein the AF may request information from the network management unit on the QoS monitoring support available from one or more network units for which the SMF provides services. The QoS monitoring support notification request may be received by the interfaces 43 in conjunction with the processor 41 of the network management unit 40A shown in FIG. 4A, where the processor 41 may be executing instructions stored in the memory 42. Alternatively, the QoS monitoring support notification request may be received by the receiver 44 of the network management unit 40B shown in FIG. 4B. In some embodiments, a request for QoS monitoring may be interpreted as a request for QoS monitoring support notification, and therefore no separate request for QoS monitoring support may be required.

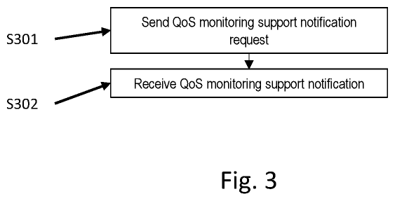

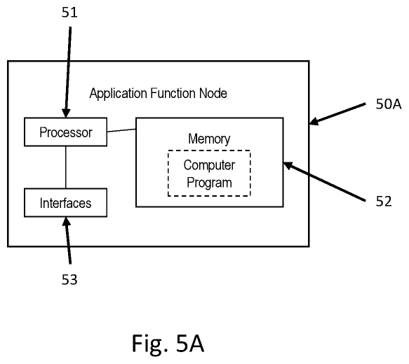

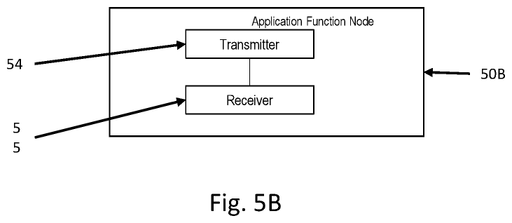

In some embodiments, the QoS monitoring support notification request may be sent by an AF node 50, as shown in step S301 of FIG. 3. The AF node may be, for example, the AF node 50 of FIG. 5A or FIG. 5B. The transmission of the request may be initiated by the interfaces 53 in conjunction with the processor 51 of the AF node 50A shown in FIG. 5A, where the processor 51 may be executing instructions stored in the memory 52. Alternatively, the transmission of the request may be initiated by the transmitter 54 of the AF node 50B shown in FIG. 5B.

Where a QoS monitoring support notification request is received by the network management unit, the request may pass directly from an AF to the network management unit. Alternatively, the request may be received at the network management unit from the AF via one or more further network components. Where the request passes via further network components, these components may comprise one or more of a PCF and/or a NEF. In some embodiments a NEF may be used, for example, where a QoS monitoring support notification request originates from a 3^{rd} party AF which has restricted access to a PCF (and/or network management unit); where this is the case the NEF may be used to authorise the request and pass the request from the 3^{rd} party AF on to the PCF/network management unit and vice versa.

In order to determine whether or not QoS monitoring is supported by at least one network units, the network management unit may detect whether the network unit(s) support QoS monitoring. The network management unit may query the one or more network units (such as UPFs or NG-RAN nodes), for example, following receipt of a QoS monitoring support notification request by the network management unit. Alternatively or additionally, the network management unit may determine whether network units support QoS monitoring when connecting to the network units, and may then store this information for subsequent reporting (for example, to an AF) when required. Alternatively or additionally, the network management unit may be sent information from the network unit(s) indicating that QoS monitoring is or is not supported, and store this information subsequent reporting.

The information on whether or to what extent the network unit(s) support QoS monitoring may be received in the form of a QoS monitoring report or reports, as shown in step S202A of FIG. 2. The QoS monitoring report(s) may be received by the interfaces 43 in conjunction with the processor 41 of the network management unit 40A shown in FIG. 4A, where the processor 41 may be executing instructions stored in the memory 42. Alternatively, the QoS monitoring report(s) may be received by the receiver 44 of the network management unit 40B shown in FIG. 4B. The QoS monitoring report may be a simple indication that a network unit does or does not support QoS monitoring, however typically the QoS monitoring report may specify what forms of QoS monitoring are supported by the network unit. QoS monitoring reports may relate to a single network unit, or to a plurality of network units. Alternatively, and particularly where network units do not support QoS monitoring, the network management unit may not receive a QoS monitoring report from one or more network units. If the network management unit does not receive a QoS monitoring report from a given network unit within a predetermined time frame, the network management unit may determine that the given network unit does not support QoS monitoring.

Following the determination of whether the one or more network units support QoS monitoring (which may or may not involve the receipt of one or more QoS monitoring reports from the network unit(s), as discussed above), the network management unit typically then sends a QoS monitoring support notification (see step S203 of FIG. 2). As shown in FIG. 2, the QoS monitoring support notification is typically sent when the network units do support QoS monitoring (S203A), and when the network units do not support QoS monitoring (S203B), although it is possible that no QoS monitoring support notification may be sent when QoS monitoring is fully supported; where this is the case, a QoS report may instead be sent. In the FIG. 2 example, no QoS monitoring report is received prior to the sending of the QoS monitoring support notification indicating that QoS monitoring is not supported; in alternative examples a QoS monitoring report indicating no QoS monitoring support may be received by the network management unit prior to the sending of the QoS monitoring support notification. The QoS monitoring support notification(s) may be sent by the interfaces 43 in conjunction with the processor 41 of the network management unit 40A shown in FIG. 4A, where the processor 41 may be executing instructions stored in the memory 42. Alternatively, the QoS monitoring support notification(s) may be sent by the transmitter 46 of the network management unit 40B shown in FIG. 4B.

In some embodiments, particularly when a QoS monitoring support notification request is received from an AF, QoS monitoring support notification(s) may be sent to the AF. The QoS monitoring support notification(s) may be sent directly to the AF, or alternatively may be sent to the AF via one or more further network components (such as a PCF and/or NEF). Typically, although not exclusively, when a QoS monitoring support notification request has been received at the network management unit from an AF via one or more further network components, the resulting QoS monitoring support notification(s) may be sent to the AF via the same further network components. That is, if the QoS monitoring support notification request is received at the network management unit via a PCF and NEF, the QoS monitoring support notification(s) may be received at the AF via the PCF and NEF. The receipt of the QoS monitoring support notification(s) by an AF node in accordance with embodiments is shown in step S302 of FIG. 3. The receipt of the notification may be performed by the interfaces 53 in conjunction with the processor 51 of the AF node 50A shown in FIG. 5A, where the processor 51 may be executing instructions stored in the memory 52. Alternatively, the receipt of the notification may be performed by the receiver 55 of the AF node 50B shown in FIG. 5B.

As discussed above, QoS monitoring support notification(s) may be sent following receipt of a request from an AF. Additionally or alternatively, a further QoS monitoring support notification may be sent following a change of UPF and/or a change of NG-RAN. It may be particularly useful to send QoS monitoring support notification(s) following changes of network unit (such as UPF or NG-RAN) as these changes may result in an alteration in the QoS monitoring that is supported. By way of example, a UPF that supports QoS monitoring may be changed for a UPF that does not support QoS monitoring, or vice versa. Such alterations of QoS monitoring may be useful information for AF. When sent, the further QoS monitoring support notification following a network unit (such as UPF or NG-RAN) change may be received by an AF node; the further QoS monitoring support notification may be received by the AF node directly from the network management unit, or via one or more further network components.

In order to implement embodiments, a new event/Policy Control Request (PCR) may be utilised, “QOS_MON_SUPPORT”. When during the QoS monitoring request, the AF subscribes to QOS_MON_SUPPORT, the PCF may subscribe with the SMF (an example of a network management unit) to the report of QoS Monitoring Support outcome by provisioning the QOS_MON_SUPPORT policy control request trigger together with the QoS Monitoring Information for the PCC rule. When the SMF receives the QoS Monitoring request for a PCC rule, the QOS_MON_SUPPORT trigger may be provisioned. If the UPF does not support QoS Monitoring, the SMF may then report to the PCF, including the NEW qosMonSupp attribute, an enumeration that, in this case, indicates QOS_MON_NOT_SUPPORTED. The PCF may then forward the received indication to the AF, in the report of the event QOS_MON_SUPPORT.

When the SMF receives the QoS Monitoring request for a PCC rule indicating Direct Notification, the QOS_MON_SUPPORT trigger may then be provisioned. If the UPF does not support Direct Notification, the SMF may then report to the PCF, including the qosMonSupp attribute, an enumeration that, in this case, indicates DIRECT_NOTIF_NOT_SUPPORTED. The PCF may then forward the received indication to the AF.

If at UPF relocation and/or NG-RAN change (for example, due to mobility) the QoS Monitoring or Direct Notification features applicability changes from supported to not supported, the SMF may then report the lack of support as described in the paragraphs above, including the QOS_MON_SUPPORT policy control request trigger.

If at UPF relocation and/or NG-RAN change the QoS Monitoring or Direct Notification features applicability changes from not supported to supported, the SMF may then report the available support as described above, but with the qosMonSupp attribute indicating QOS_MON_SUPPORTED or DIRECT_NOTIF_SUPPORTED, and including the QOS_MON_SUPPORT policy control request trigger.

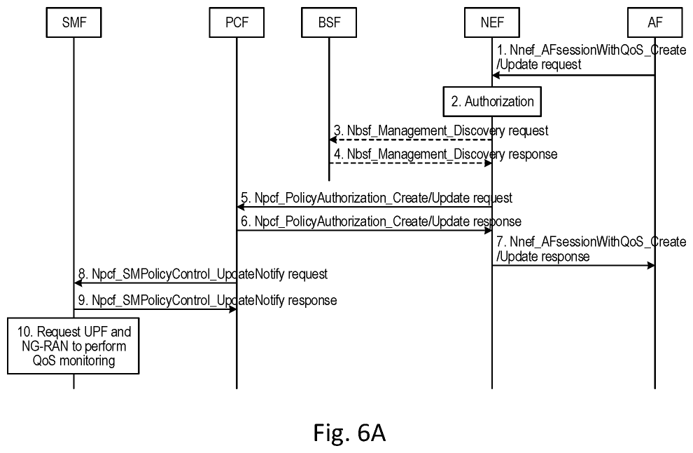

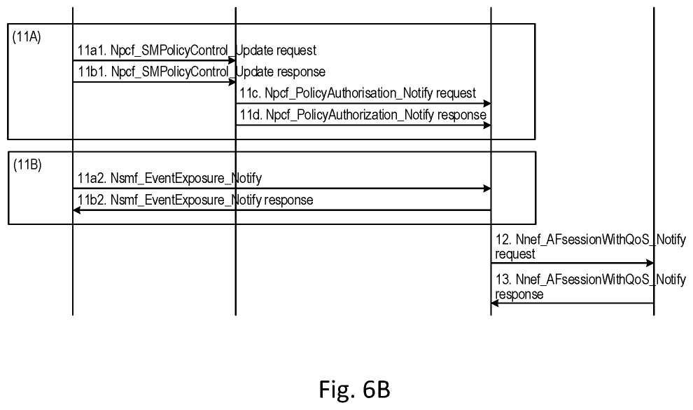

A detailed sequence diagram showing steps which may be performed in an example QoS monitoring procedure in accordance with embodiments is shown in FIG. 6A and FIG. 6B, collectively FIG. 6. One or more of the steps shown in this figure may be omitted. FIG. 6 also includes additional steps which may be used, for example, to establish a session, but which do not necessarily form part of embodiments.

In FIG. 6, the different functions which may be involved in the QoS monitoring procedure are indicated across the top of the figure, and the steps that may be performed are numbered down the side of the figure. The functions listed across the top of the figure may be hosted in any suitable physical apparatus, for example, in network management units and/or AF nodes as discussed above.

The FIG. 6 sequence diagram is based on FIG. 5.5.9-1 from 3GPP TS 29.513 V17.7.0, a technical report of the 3rd Generation Partnership Project available at https://portal.3gpp.org/desktopmodules/Specifications/SpecificationDetails.aspx? specificationId=3354 as of 20 Jul. 2022. TS 29.513 V17.7.0 section 5.5.9 discusses existing QoS monitoring procedures; as deletion related procedures are not relevant to the present disclosure, these have been omitted from FIG. 6. Further, in the example shown in FIG. 6, a NEF is used to pass communications between the AF and the PCF; as discussed above alternative communication arrangements between an AF and a PCF/SMF may also be used.

As shown in Step 1 of FIG. 6, the AF subscribes to or unsubscribes from the QoS monitoring notification from the PCF via the NEF. To create a subscription to the QoS monitoring information, in the FIG. 6 example the AF invokes the Nnef_AFsessionWithQoS_Create service operation to the NEF by sending the HTTP POST request to the “AS Session with Required QoS Subscriptions” resource. If the feature “EnEDGE” is supported, the AF may request the direct event notification from the UPF. If the feature “QoSMonitoringSupportReport” is supported, the AF may request the report about the availability of QoS Monitoring and Direct Notification in 5GC. As shown in Step 2 of FIG. 6, the NEF receives and authorises the AF request.

In Steps 3 and 4 of the FIG. 6 example, the NEF may invoke the Nbsf_Management_Discovery service operation, specified in section 8.5.4 of TS 29.513 V17.7.0, to obtain the selected PCF ID for the ongoing PDU session identified by the individual UE address in the AF request, where the PCF address is not available on the NEF based on local configuration. This information may be obtained from a Binding Support Function (BSF), as shown in FIG. 6.

As shown in Steps 5 and 6 of the FIG. 6 example, the NEF then forwards the AF request to the PCF. When receiving the Nnef_AFsessionWithQoS_Create request in step 1, the NEF may invoke the Npcf_PolicyAuthorization_Create service operation by sending the HTTP POST request to the “Application Sessions” resource as described in section 5.2.2.2.2.1 of TS 29.513 V17.7.0. When receiving the Nnef_AFsessionWithQoS_Update request in step 1, the NEF may invoke the Npcf_PolicyAuthorization_Update service operation by sending the HTTP PATCH request to the “Individual Application Session Context” resource as described in section 5.2.2.2.2.2 of TS 29.513 V17.7.0. When receiving the Nnef_AFsessionWithQoS_Delete request in step 1, the NEF may invoke the Npcf_PolicyAuthorization_Delete service operation by sending the HTTP POST request to the “Individual Application Session Context” resource as described in section 5.2.2.2.2.3 of TS 29.513 V17.7.0. Where the feature “QoSMonitoringSupportReport” is supported, the NEF may forward the request about the report about the availability of QoS Monitoring and Direct Notification in 5GC. Subsequently, in Step 7, the NEF sends the HTTP response message to the AF.

In Step 8 of the FIG. 6 example the PCF invokes the Npcf_SMPolicyControl_UpdateNotify service operation to update the SMF with corresponding PCC rule(s) by sending the HTTP POST request to the callback URI “{notificationUri}/update” as described in section 5.2.2.2.1 of TS 29.513 V17.7.0 If the AF subscribes to QoS monitoring event, the PCF may include the related subscription information within the corresponding PCC rule(s). If the PCF determines that the QoS monitoring event notification should be sent to the NEF directly from the SMF, or when the feature “EnEDGE” is supported, the PCF received the indication of direct QoS monitoring event notification, the PCF includes the notification URI pointing to the NEF within the “notifUri” attribute, the notification correlation id assigned by the NEF within the “notifCorreId” attribute and the direct QoS monitoring event notification within the “directNotifInd” attribute, if available, as specified in 3GPP TS 29.512 [9].

If the AF subscribes to the report of QoS monitoring support, the PCF may include the subscription to the QOS_MON_SUPPORT policy control request trigger when updating the SMF. If the AF unsubscribes from QoS monitoring event/support, the PCF may remove the related subscription information from the corresponding PCC rule(s). Additional background information on the communication from the PCF to the SMF may be found in 3GPP TS 29.512 V17.7.0, a technical report of the 3rd Generation Partnership Project available at https://portal.3gpp.org/desktopmodules/Specifications/SpecificationDetails.aspx?specificationId=3352 as of 20 Jul. 2022.

In Step 9 of the FIG. 6 Example, the SMF sends an HTTP 200 OKresponse message to the PCF. If the PCF subscribed to the report of QoS monitoring support events and, and the feature “QoSMonitoringSupportReport” is supported, then in the event the SMF detects that the UPF does not support QoS monitoring (there is a PFCP session established with the UPF, and the UPF reports that QoS monitoring feature is not supported), the SMF may report QoS monitoring is not supported to the PCF. Where the SMF detects that the UPF does not support Direct Notification, and the PCF requested Direct Notification, (there is a PFCP session established with the UPF, and the UPF reports that Direct Notification feature is not supported), then the SMF may report Direct Notification is not supported to the PCF. When any of these errors occur, and the feature “QoSMonitoringSupportReport” is supported between the NEF and the PCF, the PCF may invoke the Npcf_PolicyAuthorization_Notify service operation (described in more detail with reference to Step 11c below) to forward the notification with the QoS monitoring support indication to the NEF. Additionally or alternatively, the SMF may report QoS monitoring is not supported in a subsequent Npcf_SMPolicyControl_Update service operation to the PCF, including the QOS_MON_SUPPORT policy control request trigger; this may be the service operations discussed below with reference to steps 11A or 11B.

When the SMF receives the PCC rule, as shown in Step 10 of the FIG. 6 Example, the SMF may send a QoS Monitoring request to one or more of the UPF and NG-RAN (as also discussed in 3GPP TS 29.512 V17.7.0). When the SMF receives the indication of direct QoS monitoring event notification within the PCC rule, if the UPF supports direct notification, the SMF shall send to the UPF the request to report directly to the NEF the QoS monitoring events.

Subsequently, one of Step 11A and 11B may be implemented. Step 11A may be implemented when, in Step 8, the PCF determines that the notification shall be sent to the NEF via the PCF. Step 11B may be implemented when, in Step 8 the PCF determines that the notification shall be sent to the NEF directly from the SMF.

In Step 11A, specifically in Steps 11a1 and 11b1, upon receipt of the QoS monitoring report from the UPF, or when the SMF detects the NG-RAN does not support QoS Monitoring, the SMF may invoke the Npcf_SMPolicyControl_Update service operation to the PCF by sending an HTTP POST request to the “Individual SM Policy” resource. The QoS Monitoring report may include QOS_MONITORING policy control request trigger, or QoS Monitoring is not supported including the QOS_MON_SUPPORT policy control request trigger. The PCF sends an HTTP POST response to the SMF. Steps 11a1 and 11ba are also applicable for RAN or UPF relocation (for example due to mobility events), wherein the use of new RAN or new inserted I-UPF result in QoS Monitoring support capability change from supporting QoS Monitoring to not supporting QoS Monitoring or vice versa.

In Step 11A, specifically in Step 11c and 11d, upon receipt of the QoS monitoring event notification from the SMF, the PCF may invoke the Npcf_PolicyAuthorization_Notify service operation to forward the notification to the NEF by sending the HTTP POST request to the callback URI “{notifUri}/notify”. The NEF may then send an HTTP POST response to the PCF.

In Step 11B, specifically in Step 11a2 and 11b2, upon receipt of the QoS monitoring report from the UPF, or when the SMF detects NG-RAN does not support QoS Monitoring, the SMF may invoke Nsmf_EventExposure_Notify service operation to forward the notification to the NEF by sending an HTTP POST request to the callback URI “{notifUri}” received in Step 8. The NEF may then send an HTTP POST response to the SMF. Step 11a2 and 11b2 are also applicable for RAN or UPF relocation (for example due to mobility events) wherein the use of new RAN or new inserted I-UPF result in QoS Monitoring support capability change from supporting QoS Monitoring to not supporting QoS Monitoring or vice versa.

Subsequently, in Step 12 and Step 13, upon receipt of the QoS monitoring information (as discussed in Step 11), the NEF may invoke the Nnef_AFsessionWithQoS_Notify service operation to forward the QoS monitoring information (QOS monitoring report or, if the feature “QoSMonitoringSupportReport” is supported and it was requested information about QoS monitoring support, QoS monitoring support information) to the AF.

In some embodiments, at UPF relocation: the new UPF may support the QoS monitoring feature or the Direct Notification feature, wherein it was previously reported that QoS monitoring or Direct Notification was not supported; or the new UPF may not support QoS monitoring feature or the Direct Notification feature wherein it was supported by the previous UPF. Similarly, in some embodiments, at NG-RAN change: the new NG-RAN may support the QoS monitoring feature, wherein it was previously reported that QoS monitoring was not supported; or the new NG-RAN may not support the QoS monitoring feature, wherein it was previously reported that QoS monitoring was supported. In either of these scenarios, if the PCF supports the “QoSMonitoringSupportReport” feature, and the PCF subscribed to the QOS_MON_SUPPORT policy control request trigger, the SMF may send to the PCF the QoS monitoring support indication together with the policy control request trigger, as applicable, invoking the Npcf_SMPolicyControl_Update service operation. When this indication occurs, and the feature “QoSMonitoringSupportReport” is supported between the NEF and the PCF, the PCF may invoke the Npcf_PolicyAuthorization_Notify service operation to forward the notification with the QoS monitoring support indication to the NEF.

Although the example of FIG. 6 is discussed in the context of a 5G network architecture, an analogous procedure may be performed in a 4G network architecture where the RAN supports the required measurements. In an analogous 4G network procedure, the 4G functionality equivalent to the 5G functionality discussed above may equate to replacing: the AF with a Service Capability Server/Application Server (SCS/AS); the PCF with a Policy and Charging Rules Function (PCRF); the SMF with a PDN Gateway Control plane function or Traffic Detection Function Control plane function (PGW-C or TDF-C); the UPF with a PGW User plane function or TDF User plane function (PGW-U or TDF-U); the SMF with a Packet Gateway (PGW) Control plane (PGW-C) or Traffic Detection Function (TDF) Control plane (TDF-C); the UPF with a PGW User plane (PGW-U) or TDF User plane (TDF-U); and the BSF with a Diameter Routing Agent (DRA).

It will be understood that the detailed examples outlined above are merely examples. According to embodiments herein, the steps may be presented in a different order to that described herein. Furthermore, additional steps may be incorporated in the method that are not explicitly recited above. For the avoidance of doubt, the scope of protection is defined by the claims.

1. A method for Quality of Service, QoS, monitoring support notification in a communication network, the method comprising:
determining, by a network management unit, whether or not QoS monitoring is supported by at least one network unit;
if it is determined that QoS monitoring is supported by the at least one network unit, receiving a QoS monitoring report and sending a QoS monitoring support notification or, if it is determined that QoS monitoring is not supported by the at least one network unit, sending a QoS monitoring support notification; and
prior to determining whether or not QoS monitoring is supported by at least one further network unit:
receiving a QoS monitoring support notification request from an Application Function, AF; and
sending the QoS monitoring support notification to the AF.

2. (canceled)

3. The method of claim 1, wherein one or both:
the QoS monitoring support notification request is received at the network management unit from the AF via one or more further network components; and
the QoS monitoring support notification is sent to the AF via one or more further network components.

4. The method of claim 3, wherein one or both:
the one or more further network components comprise a Policy Control Function, PCF; and
the one or more further network components comprise a Network Exposure Function, NEF.

5. The method of claim 1, wherein the at least one network unit comprises a User Plane Function, UPF.

6. The method of claim 5, further comprising, following a UPF relocation, sending a further QoS monitoring support notification to the AF.

7. The method of claim 1, wherein the at least one network unit comprises a Next Generation Radio Access Node, NG-RAN.

8. The method of claim 7, further comprising, following a NG-RAN change, sending a further QoS monitoring support notification to the AF.

9. (canceled).

10. A method for Quality of Service, QoS, monitoring support notification in a communication network, the method comprising:
sending, by an Application Function, AF, node a QoS monitoring support notification request to a network management unit; and
receiving, by the AF node, a QoS monitoring support notification from the network management unit.

11. The method of claim 10, wherein the network management unit is a Session Management Function, SMF.

12. The method of claim 10, wherein the one or both of the QoS monitoring support notification request and the QoS monitoring support notification pass between the AF node and the network management unit via one or more further network components.

13. (canceled)

14. (canceled)

15. The method of claim 1, further comprising:
sending, by an Application Function, AF, node a QoS monitoring support notification request to a network management unit; and
receiving, by the AF node, a QoS monitoring support notification from the network management unit.

16. A network management unit for Quality of Service, QoS, monitoring support notification in a communication network, the network management unit comprising processing circuitry and a non-transitory machine-readable medium storing instructions to configure the network management unit to:
determine whether or not QoS monitoring is supported by at least one network unit;
if it is determined that QoS monitoring is supported by the at least one network unit, receive a QoS monitoring report and send a QoS monitoring support notification or, if it is determined that QoS monitoring is not supported by the at least one network unit, send a QoS monitoring support notification; and
prior to determining whether or not QoS monitoring is supported by at least one further network unit:
receive a QoS monitoring support notification request from an Application Function, AF; and
send the QoS monitoring support notification to the AF.

17. The network management unit of claim 16, further configured, prior to determining whether or not QoS monitoring is supported by at least one further network unit:
to receive a QoS monitoring support notification request from an Application Function, AF; and
to send the QoS monitoring support notification to the AF.

18. The network management unit of claim 17, further configured to one or both:
receive the QoS monitoring request from the AF via one or more further network components; and
send the QoS monitoring support notification to the AF via one or more further network components.

19. (canceled)

20. The network management unit of claim 17, wherein the at least one network unit comprises a User Plane Function, UPF.

21. The network management unit of claim 20, further configured, following a UPF relocation, to send a further QoS monitoring support notification to the AF.

22. The network management unit of claim 16, wherein the at least one network unit comprises a Next Generation Radio Access Node, NG-RAN.

23. (canceled)

24. (canceled)

25. An Application Function, AF, node for Quality of Service, QoS, monitoring support notification in a communication network, the AF node comprising processing circuitry and a non-transitory machine-readable medium storing instructions to configure the AF node to:
send a QoS monitoring support notification request to a network management unit; and
receive a QoS monitoring support notification from the network management unit.

26. The AF node of claim 25, wherein the network management unit is a Session Management Function, SMF.

27. The AF node of claim 25, further configured such that one or both of the QoS monitoring support notification request and the QoS monitoring support notification pass between the AF node and the network management unit via one or more further network components.

28-30. (canceled)
